(19) United States
(12) Patent Application Publication
(10) Pub. No.: US 2007/0188784 A1
(43) Pub. Date: Aug. 16, 2007

(54) Image Scanning Device, and Calibration Method of the Image Scanning Device

(75) Inventor: Naoki Nishioka, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/670,353

(22) Filed: Feb. 1, 2007

(30) Foreign Application Priority Data
Feb. 13, 2006 (JP) 2006-034809

(51) Int. Cl. G06F 15/00

(52) U.S. Cl. 358/1.9; 358/504

(57) ABSTRACT

An image scanning device determines a size of a test chart placed on a scanner unit, and selects a storage unit storing target brightness of a plurality of patches of a test chart having the determined size and corresponding position information. The image scanning device scans the test chart by a photoelectric conversion element, and compares brightness at a prescribed position on the test chart with target brightness corresponding to the prescribed position retrieved from the storage unit to calibrate a correction circuit.

### RELATED APPLICATIONS

This application claims priority under 35 USC 119 in Japanese application no. 2006-034809, filed on Feb. 13, 2006, which application is incorporated by reference in its entirety.

### BACKGROUND OF THE INVENTION

1. Field of the Invention

The present invention relates to an image scanning device of a digital Multi Function Peripheral (MFP) and a facsimile machine or the like, and a calibration method of the image scanning device. In particular, the present invention relates to calibration of a correction circuit for correcting a scan signal of the image scanning device.

2. Description of the Related Art

Recently, a greater number of image scanning devices of digital MFPs and facsimile machines or the like, which include a copier function, a facsimile function, a printer function, and a scanner function or the like, are provided with a color scanner function. In order to adjust a difference in brightness characteristics of Red, Green, and Blue (RGB), i.e., in order to adjust a balance of gradation characteristics (gamma characteristics), a gamma correction table is generated for each color from values obtained by scanning an exclusive test chart, and a color difference is adjusted to be small. Differences in balance are also generated for an Auto Document Feeder (ADF) and a Flat Bed Scanner (FBS). Therefore, a gamma correction table is automatically created for the ADF and the FBS to eliminate such differences.

As described above, the conventional image scanning device calibrates a gamma correction table such that each device has the same scanning characteristics for color images. When a maximum scanning size of an original document is the International Organization for Standardization (ISO) A4 size, the image scanning device preferably uses an A4-sized test chart. When the maximum scanning size of an original document is the ISO A3 size, the image scanning device preferably uses an A3-sized test chart. At shipment from a factory, calibration is executed using a test chart of a maximum scanning size as described above.

Meanwhile, when replacing components such as a light source, a Charge Coupled Device (CCD), or an element of a circuit of a signal processor, it becomes necessary to carry out such calibration in the field. When a test chart is folded, shades etc. are generated in the folded portion, and calibration is not carried out accurately. In particular, when the test chart is A3-sized, since the test chart cannot be folded or crumpled, it is difficult to carry around relative to smaller test charts, for such as A4-sized test charts, placing more workload on a serviceperson.

Therefore, an A4-sized test chart is used for the calibration of a scanner having a maximum scanning size of A4 or A3 size. When calibrating, the color test chart size must be set, and calibration of either the ADF or the FBS must be set. As a result, workload increases, the operation for creating the gamma correction table becomes complicated, and the serviceperson is more likely to make errors.

### SUMMARY OF THE INVENTION

In order to overcome the problems described above, the present invention provides an image scanning device and calibration method which easily calibrates a correction circuit for a test chart of any size just by setting the test chart at the device.

According to a first aspect of the present invention, an image scanning device includes a photoelectric conversion element, an analog-to-digital converter, a correction circuit, a first storage unit, a second storage unit, a size detecting sensor, and a calibration data generating unit. The photoelectric conversion element photoelectrically converts a color image into an analog signal of each color. The analog-to-digital converter converts the analog signal of each color output from the photoelectric conversion element into a digital signal of each color. The correction circuit performs a correction on the digital signal of each color. The first storage unit stores target brightness of a plurality of brightness patches of a test chart of a first size, and corresponding position information. The second storage unit stores target brightness of a plurality of brightness patches of a test chart of a size larger than the first size, and corresponding position information. The size detecting sensor detects a size of the test chart. The calibration data generating unit selects either the first storage unit or the second storage unit according to the size detected by the size detecting sensor, and calibrates the correction circuit according to the digital signal of each color obtained by scanning the color image by the photoelectric conversion element and the target brightness corresponding to a position stored in the selected storage unit.

According to a second aspect of the present invention, the correction circuit is a gamma correction circuit. According to a third aspect of the present invention, the calibration data generating unit determines as to whether the test chart has been set on the ADF or the FBS.

According to a fourth aspect of the present invention, the image scanning device determines a size of the test chart set at a scanner unit, and selects a storage unit storing target brightness of a plurality of brightness patches of a test chart of the determined size and corresponding position information. The image scanning device scans the test chart by the photoelectric conversion element, and compares the brightness at a prescribed position on the test chart with the target brightness corresponding to the prescribed position retrieved from the storage unit, and calibrates the correction circuit.

According to these aspects of the present invention, the image scanning device determines the size of the test chart set at the scanner unit, and automatically selects the storage unit storing the target brightness of a plurality of brightness patches of the test chart of the determined size and corresponding position information. Then, the image scanning device compares the target brightness at the prescribed position on the test chart retrieved from the selected storage unit with a value of a scan signal of the prescribed position on the test chart, and calibrates the correction circuit. Therefore, without requiring an operator to set the test chart size by which calibration will be executed, calibration data of the correction circuit is generated easily just by setting a test chart at the scanner unit.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a diagram of a network configuration of a system including a digital MFP.

FIG. 2 is a block diagram of a hardware configuration of the digital MFP.

FIG. 3 is a block diagram of an image correction circuit of a color image and black and white (B/W) image signal processor.

FIG. 4 is an example of a test chart used for creating a gamma correction table.

FIG. 5 is an example of a display of a service menu.

FIG. 6 is a flowchart of processes carried out when creating a gamma correction table.

FIG. 7 is an example of contents of a display when executing color gamma correction.

FIG. 8 is a graph of gamma characteristics calculated from target brightness of a subject range of each patch and scanning brightness of the subject range.

FIG. 9 is a graph of interleaved gamma characteristics, target gamma characteristics, and a gamma correction table.

### DETAILED DESCRIPTION OF THE INVENTION

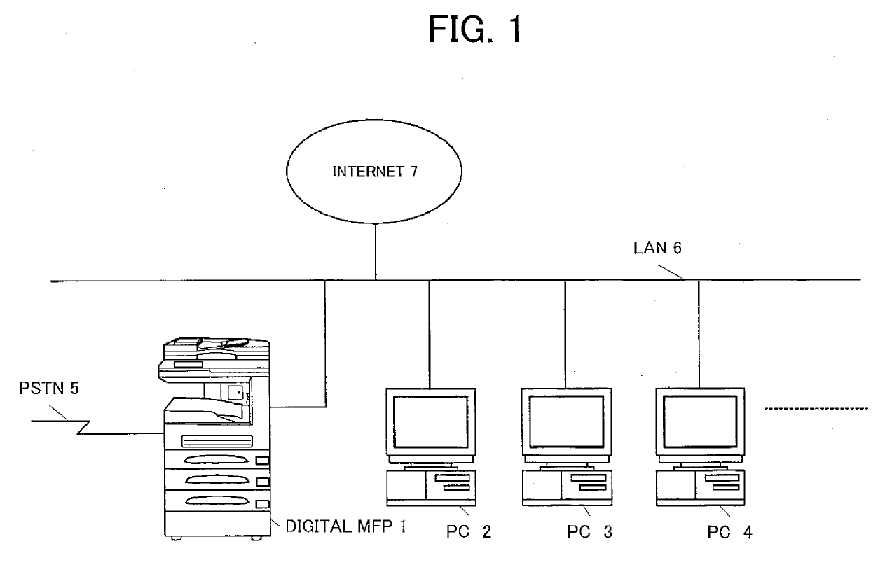

Embodiments of the present invention in which an image scanning device of the present invention is applied to a digital MFP are now described. FIG. 1 is a diagram of a network configuration of a system including the digital MFP.

In FIG. 1, reference numeral 1 denotes a digital MFP, 2, 3, and 4 each denote a Personal Computer (PC), 5 denotes a Public Switched Telephone Network (PSTN), 6 denotes a Local Area Network (LAN), and 7 is the Internet. The digital MFP 1 includes a copy mode, a printer mode, a facsimile mode, and an e-mail transmitting function. The digital MFP 1 is connected to the PSTN 5 and the LAN 6. PCs 2, 3 and 4 are connected to the LAN 6 as terminal devices. The LAN 6 is also connected to the Internet 7. The digital MFP 1 can transmit and receive e-mail via the Internet 7.

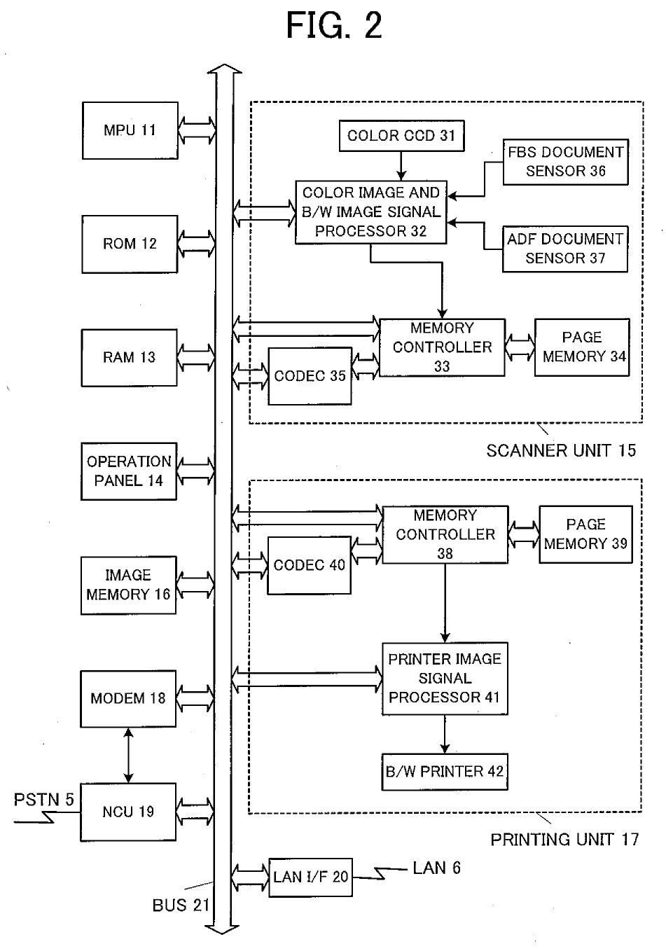

FIG. 2 is a block diagram schematically illustrating a configuration of the digital MFP 1. As illustrated in FIG. 2, the digital MFP 1 includes a Micro Processing Unit (MPU) 11, a Read Only Memory (ROM) 12, a Random Access Memory (RAM) 13, an operation panel 14, a scanner unit 15, an image memory 16, a printing unit 17, a modulator-demodulator (MODEM) 18, a Network Control Unit (NCU) 19, and a LAN interface (LAN I/F) 20. Units 11-20 are connected via a bus 21.

The MPU 11 controls each of the hardware components of the digital MFP 1 via the bus 21, and executes various programs stored in the ROM 12. The ROM 12 stores various programs and operation messages necessary for operation of the digital MFP 1. The ROM 12 previously stores position information of a prescribed patch of A3-sized and A4-sized test charts, and target brightness associated with such position information. The RAM 13 is a Static RAM (SRAM) or the like, and stores temporary data generated when a program is executed. The operation panel 14 displays an operation status of the digital MFP 1. The operation panel 14 includes a display unit, which displays an operation screen of various functions, and a plurality of keys for operating the digital MFP 1.

The scanner unit 15 includes an original document placing table for an ADF and/or an FBS. The scanner unit 15 scans an original document by a scanner using a CCD or the like, and outputs an image signal. As illustrated in the drawing, the scanner unit 15 includes a color CCD 31, a color image and B/W image signal processor 32, a memory controller 33, a page memory 34, a Coder-and-Decoder (CODEC) 35, an FBS document sensor 36, and an ADF document sensor 37.

The color CCD 31 is a four-channeled CCD of R, G, B, and black (K). The color CCD 31 scans an original document, and outputs three color signals R, G, and B and a monochrome signal (B/W) for one channel. The color image and B/W image signal processor 32 generates digital image data of black and white and three colors R, G, and B (each color is 8-bits data) according to the image signals from the color CCD 31. The color image and B/W image signal processor 32 converts RGB image data into image data of three components Y, C and C (luminance, color difference 1, and color difference 2) by a colormetric reference changing system, or Lab image data by a colormetric reference system including a value, chroma, and hue felt by a human being.

The memory controller 33 stores such data in the page memory 34. The CODEC 35 for the Joint Photographic Coding Experts Group (JPEG) compresses YCC multi-level data or Lab multi-level data stored in the page memory 34 by the JPEG, and also expands compressed data.

The image memory 16 is a Dynamic RAM (DRAM) or the like. The image memory 16 stores transmission image data, received image data, or image data scanned by the scanner unit 15. The printing unit 17 includes a black-and-white (B/W) printer. The printing unit 17 prints out received data, copied original document data, or print data transmitted from the remote PCs 2, 3, and 4, etc. As illustrated in the drawing, the printing unit 17 includes a memory controller 38, a page memory 39, a CODEC 40, a printer image signal processor 41, and a B/W printer 42.

When printing, the memory controller 38 expands an image signal from the image memory 16 by the CODEC 40, and stores image data of one page in the page memory 39. Then, the memory controller 38 retrieves the image data from the page memory 39, and supplies the image signal to the printer image signal processor 41. The printer image signal processor 41 inputs a control signal for a B/W image to the B/W printer 42.

The MODEM 18 is connected to the bus 21. The MODEM 18 includes functions as a faxmodem capable of carrying out facsimile communication. The MODEM 18 is connected to the NCU 19, which is also connected to the bus 21. The NCU 19 is hardware which carries out an operation for connecting and releasing an analog communication line. According to necessity, the NCU 19 connects the MODEM 18 to the PSTN 5. The LAN interface 20 is connected to the LAN 6. The LAN interface 20 receives a signal from the Internet 7, and also transmits a signal and data to the LAN 6. The LAN interface 20 executes an interface processing such as a signal conversion and a protocol conversion.

The digital MFP 1 is configured as described above. At facsimile transmission, image data of an original document is scanned by the scanner unit 15, compressed by the CODEC 35, and stored in the image memory 16. The compressed image data is retrieved from the image memory 16, demodulated by the MODEM 18, and transmitted from the NCU 19 to a communication destination via the PSTN 5. At facsimile reception, received image data is demodulated by the MODEM 18, and stored in the image memory 16. Then, the image data is expanded by the CODEC 40, and printed out by the B/W printer 42.

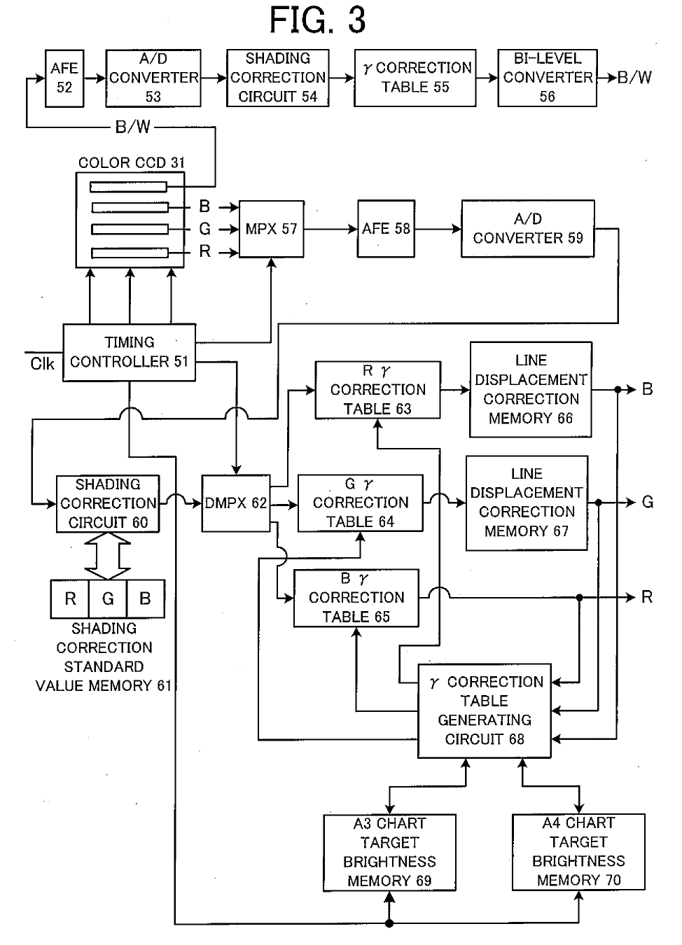

The color image and B/W image signal processor 32 is now described. FIG. 3 is a block diagram schematically illustrating an image correction circuit. A timing controller 51 generates clock per unit pixel in accordance with standard clock (Clk), and calculates the clock per such unit pixel to output a pixel address of one line. Then, the timing controller 51 decodes the pixel address, and outputs a CCD drive signal per line, such as a shift pulse and a reset pulse, an effective area signal of a scanned area of one line from the CCD, or a line synchronizing signal.

In accordance with a timing signal from the timing controller 51, a B/W sensor of the color CCD 31 optically scans an image of an original document, and outputs a B/W image signal to an Analog Front End (AFE) 52. The AFE 52 samples and holds, and amplifies the analog signal, and outputs the signal to an Analog-to-Digital (A/D) converter 53.

The A/D converter 53 converts the analog signal into, for example, 8-bits digital data (256 gradations), and inputs the digital data to the shading correction circuit 54. The shading correction circuit 54 carries out shading correction on the digital data for correcting unevenness in luminance of a light source, variation in sensitivity among cells of a CCD image sensor, or aberration of an optical system. The gamma correction table 55 executes a gamma correction on the output from the shading correction circuit 54 in accordance with a table, and inputs the output from the table to a bi-level converter 56. The bi-level converter 56 converts into a value (0 or 1) indicating whether such pixel is white or black, and outputs the value.

Meanwhile, the analog signal from an RGB sensor of the color CCD 31 is sequentially selected by a multiplexer (MPX) 57, and input to an AFE 58. The MPX 57 switches input by an output signal from the timing controller 51. In the same manner as described above, the analog signal is sampled and held, and amplified by the AFE 58, and output to the A/D converter 59.

The image data, which has been converted into 8-bits digital data by the A/D converter 59, is input to a shading correction circuit 60. In accordance with a shading correction standard value for each color stored in a shading correction standard value memory 61, the shading correction circuit 60 executes a shading correction for correcting unevenness in luminance of the light source, variation in sensitivity among cells of a CCD image sensor, or aberration of an optical system. That is, as the shading correction data, the shading correction standard value memory 61 stores the output from the A/D converter 59 of when an original document has been scanned. Meanwhile, the shading correction circuit 60 uses the shading correction data to correct the output from the A/D converter 59 of when an original document has been scanned, and outputs the corrected multi-level data.

The output from the shading correction circuit 60 is sequentially output to an R gamma correction table 63, a G gamma correction table 64, and a B gamma correction table 65. Further, the output is sequentially switched by a demultiplexer (DMPX) 62. Further, the DMPX 62 switches the output of the shading correction circuit 60 by the output from the timing controller 51. In order to achieve ideal gradation characteristics, the gamma correction tables 63-65 of each of the colors execute brightness correction (control to correct gradation) of the image data. Among signals of each of the colors of which the brightness has been corrected, an R signal and a G signal are input to line displacement correction memories 66 and 67, respectively.

Since the color image sensors of the color CCD 31 for each of the colors R, G, and B scan an image at different positions, each output from the same scanning line scanned by each of the image sensors is displaced and output. The line displacement correction memories 66 and 67 correct the displacement to match output timing, and output signals. With a B signal as a reference, an R signal and a G signal are output with delay.

Meanwhile, the gamma correction table generating circuit 68 generates a gamma correction table by comparing a value of a scan signal (brightness) at a prescribed position on a test chart placed on the scanner unit 15 with target brightness at each prescribed position retrieved from an A3 chart target brightness memory 69 and an A4 chart target brightness memory 70. The generated gamma correction table is supplied to an R gamma correction table 63, a G gamma correction table 64, and a B gamma correction table 65. In the following, a description will be made of operations carried out when generating a gamma correction table by the gamma correction table generating circuit 68.

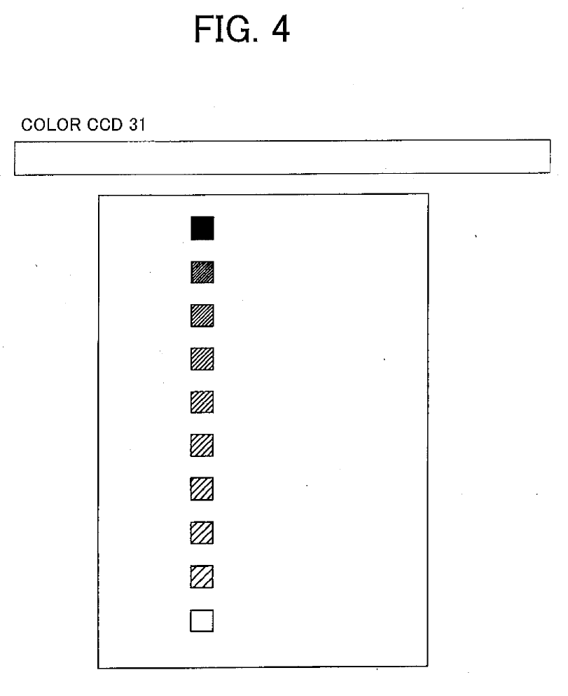

FIG. 4 illustrates an example of a test chart. As illustrated in the drawing, grayscale including ten patches is printed at prescribed positions on the test chart. The patches sequentially increase the brightness within a range from 0% to 100%. The target brightness and corresponding position information of each of the patches are stored in the A3 chart target brightness memory 69 and the A4 chart target brightness memory 70, respectively.

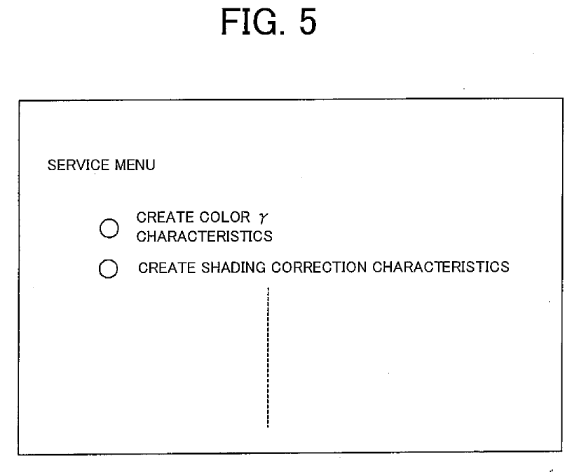

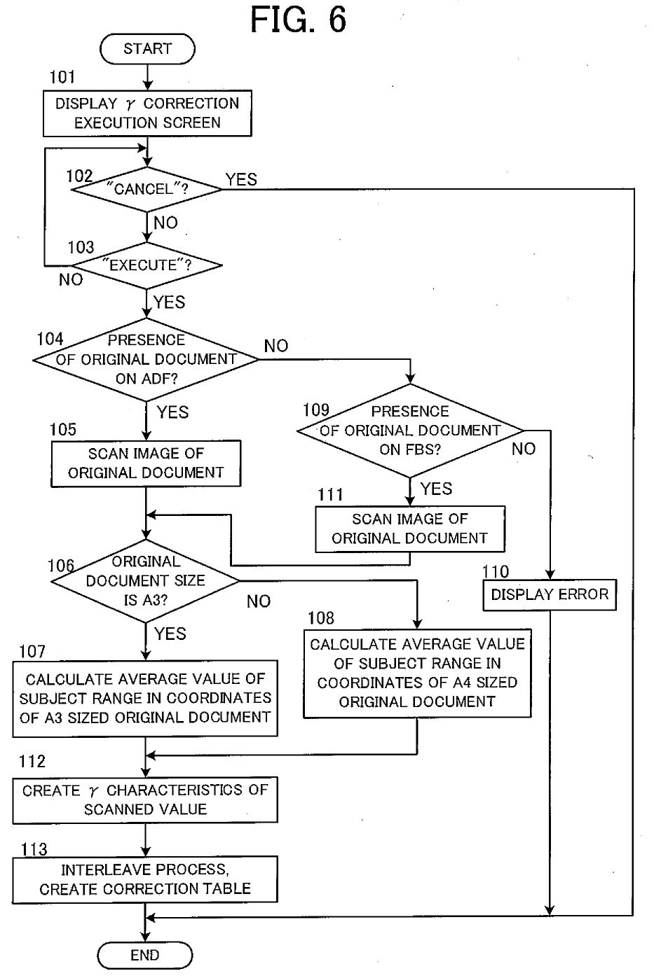

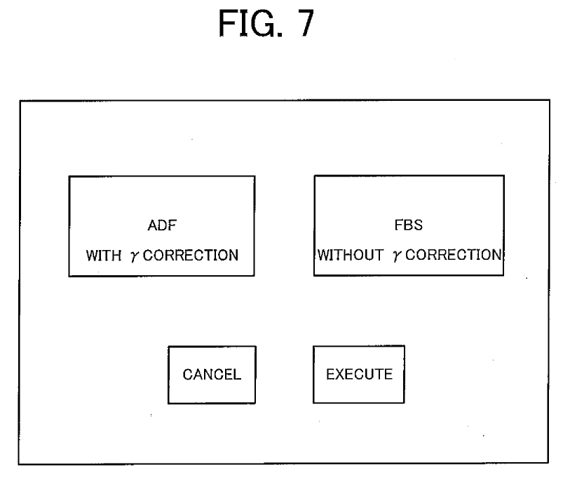

When creating color gamma characteristics at shipment from a factory or when creating color gamma characteristics by a serviceperson on the field, an operator selects maintenance from a display screen (not illustrated) of the operation panel 14, and a service menu as illustrated in FIG. 5 is displayed on the display screen. When the operator selects “create color gamma characteristics”, the MPU 11 starts a color gamma characteristics creating program illustrated in the flowchart of FIG. 6. First, the display screen of the operation panel 14 displays a color gamma correction execution screen illustrated in FIG. 7 (step 101). The color gamma correction execution screen displays a presence or an absence of gamma correction for each of the ADF and the FBS, and an “EXECUTE” button and a “CANCEL” button.

When the color gamma correction execution screen is displayed, the MPU 11 determines whether or not the “CANCEL” button has been pressed by the operator (step 102). When the MPU 11 determines that the “CANCEL” button has been pressed, the color gamma correction execution screen is closed, and the program is ended. When the MPU 11 determines that the “CANCEL” button has not been pressed, the MPU 11 determines whether or not the “EXECUTE” button has been pressed (step 103). When the MPU 11 determines that the “EXECUTE” button has not been pressed, the process returns to step 102, and the MPU 11 determines again whether or not the “CANCEL” button has been pressed. When the MPU 11 determines that the “EXECUTE” button has been pressed, the MPU 11 determines whether or not an original document is set at the ADF according to an output from the ADF document sensor 37 (step 104).

When the MPU 11 determines that an original document is set at the ADF, an image of the original document is scanned by the color CCD 31, and brightness data of each color is stored in the RAM 13 (step 105). The MPU 11 determines whether or not the size of the original document placed on the ADF is an A3 size in accordance with the output from the ADF document sensor 37 (step 106). When the MPU 11 determines that the size of the original document is an A3 size, the MPU 11 calculates an average value of brightness in a subject range of each patch in coordinates of an A3-sized original document, and stores the calculated value in the RAM 13 (step 107).

That is, by calculating the average value of the brightness in an area for each of the patches in the test chart illustrated in FIG. 4, the MPU 11 calculates the scanned brightness of each grayscale and stores the calculated brightness in the RAM 13. When the MPU 11 determines at step 106 that the size of the original document is not an A3 size, the MPU 11 calculates an average value of the brightness in a subject range of each patch in the coordinates of an A4-sized original document according to the data stored in the A4 chart target brightness memory 70, and stores the average value in the RAM 13 (step 108).

Meanwhile, when the MPU 11 determines at step 104 that an original document has been set at the ADF, the MPU 11 determines whether or not an original document is set on the FBS according to an output from the FBS document sensor 36 (step 109). When the MPU 11 determines that an original document is not set on the FBS, an error message e.g. “Test chart is not set.” is displayed (step 110), and the program is ended. When the MPU 11 determines that an original document is set on the FBS, the MPU 11 scans an image of the original document by the color CCD 31, and stores brightness data of each color in the RAM 13 (step 111). Then, in the same manner as described above, the MPU 11 determines whether or not the size of the original document is an A3 size (step 106). The MPU 11 calculates an average value of the brightness in the subject range of each patch in coordinates of the size of the original document placed on the FBS, and stores the calculated average value in the RAM 13 (steps 107 and 108).

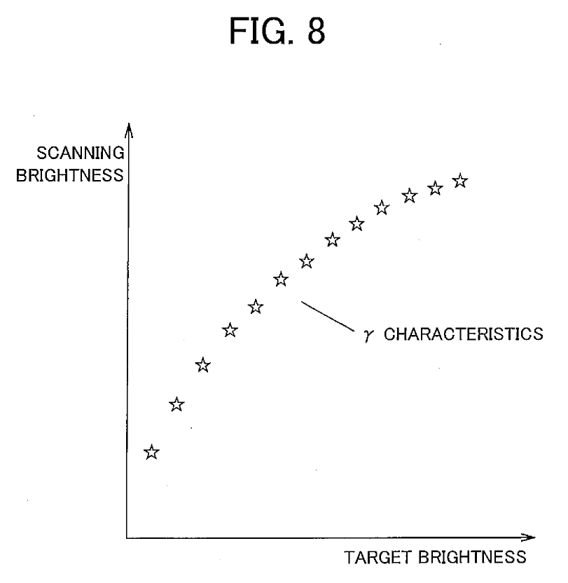

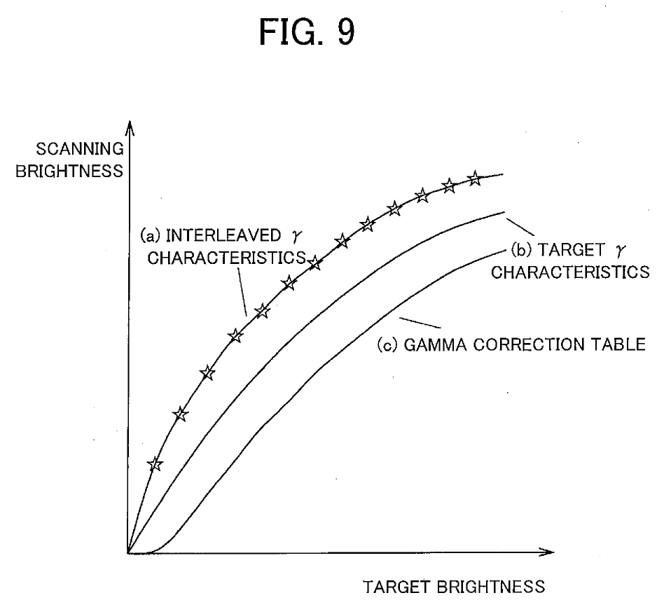

After calculating the average value of the brightness in the subject range of each patch of the test chart, the MPU 11 calculates gamma correction characteristics as illustrated in FIG. 8 from the target brightness in the subject range of each patch stored in the A3 chart target brightness memory 69 or the A4 chart target brightness memory 70, and the scanned brightness of each subject range (step 112). Next, by interleaving the gamma characteristics illustrated in FIG. 8, the MPU 11 calculates interleaved gamma characteristics illustrated by (a) in FIG. 9. By subtracting a difference between such interleaved gamma characteristics and a target gamma characteristics illustrated by (b) in FIG. 9 from each value of the target gamma characteristics, a gamma correction table as illustrated by (c) in FIG. 9 is generated (step 113). The correction table is respectively generated for the sensors of each of the colors R, G, and B. Each of the generated gamma correction tables is supplied to the R gamma correction table 63, the G gamma correction table 64, and the B gamma correction table 65.

As described above, the MPU 11 determines whether the test chart has been set on the FBS or the ADF, and automatically determines the size of the test chart set on the scanner unit. Then, by comparing the target brightness at a prescribed position on the test chart of the determined size with the brightness of the scan signal at the prescribed position, the gamma correction circuit is calibrated. Therefore, just by setting a test chart at a scanner unit, an operator can easily calibrate the gamma correction circuit without carrying out a setting as to by which color test chart of which size calibration will be executed, or a setting as to whether to calibrate the ADF or the FBS.

In the above-described embodiment, the MPU 11 executes a process for generating a correction table by software. As another example, a gamma correction table generating circuit may generate a correction table by hardware. In the above-described embodiment, two test charts for A3 and A4 sizes are used. However, test charts for sizes other than A3 and A4 sizes may be used. Alternatively, test charts for three or more different sizes may be used, and target brightness and a location of grayscale of each of the test charts may be stored.

In the above-described embodiment, stages in the brightness of the test chart include 10 stages. However, the number of stages is not limited to 10, and any number may be selected. For example, the brightness of the test chart may include 15 stages. In the above-described embodiment, an image scanning device of the present invention is applied to a digital MFP. The present invention is also applicable to a general facsimile machine and a scanner not having an e-mail function.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image scanning device comprising:
a photoelectric conversion element that photoelectrically converts a color image;
an analog to digital converter that converts an analog signal of each color output from the photoelectric conversion element into a digital signal of each color;
a correction circuit that performs a correction on the digital signal of each color;
a first storage unit that stores target brightness of a plurality of patches of a test chart of a first size and corresponding position information;
a second storage unit that stores target brightness of a plurality of patches of a test chart of a size larger than the first size and corresponding position information;
a size detecting sensor that detects a size of a test chart; and
a calibration data generating circuit that selects one of the first storage unit and the second storage unit according to the size detected by the size detecting sensor, and calibrates the correction circuit according to the digital signal of each color obtained by the photoelectric conversion element and the target brightness corresponding to a position stored in the selected storage unit.

2. The image scanning device according to claim 1, wherein the correction circuit is a gamma correction circuit.

3. The image scanning device according to claim 2, wherein the digital signal of each color includes a red digital signal, a green digital signal, and a blue digital signal, and
the correction circuit includes a gamma correction circuit for the red digital signal, a gamma correction circuit for the green digital signal, and a gamma correction circuit for the blue digital signal.

4. The image scanning device according to claim 3, wherein the gamma correction circuit for the red digital signal, the gamma correction circuit for the green digital signal, and the gamma correction circuit for the blue digital signal are respectively a table.

5. The image scanning device according to claim 1, further comprising:
an auto document feeder that scans a test chart while feeding the test chart;
a flat bed scanner that scans a standstill test chart;
a first sensor that detects whether or not a test chart has been set at the auto document feeder; and
a second sensor that detects whether or not a test chart has been set on the flat bed scanner,
wherein according to an output from the first sensor and the second sensor, the correction circuit determines whether the test chart has been set at the auto document feeder or on the flat bed scanner.

6. The image scanning device according to claim 1, wherein the patches of the test chart are formed of grayscale.

7. An image scanning device comprising:
means for photoelectrically converting a color image;
means for converting an analog signal of each color output from the means for photoelectrically converting into a digital signal of each color;
means for correcting the digital signal of each color;
means for storing target brightness of a plurality of patches of a test chart of a first size and corresponding position information;
means for storing target brightness of a plurality of patches of a test chart of a size larger than the first size and corresponding position information;
means for detecting a size of a test chart; and
means for selecting one of the means for storing according to the size detected by the means for detecting, and calibrating the correction of the digital signal according to the digital signal of each color obtained by the means for photoelectrically converting and the target brightness corresponding to a position stored in the selected means for storing.

8. The image scanning device according to claim 7, further comprising means for carrying out a gamma correction on the digital signal.

9. The image scanning device according to claim 8, further comprising:
means for carrying out a gamma correction on a red digital signal;
means for carrying out a gamma correction on a green digital signal; and
means for carrying out a gamma correction on a blue digital signal.

10. The image scanning device according to claim 9, further comprising:
means for applying the red digital signal to a gamma correction table;
means for applying the green digital signal to a gamma correction table; and
means for applying the blue digital signal to a gamma correction table.

11. The image scanning device according to claim 10, further comprising:
means for generating the gamma correction table of the red digital signal
means for generating the gamma correction table of the green digital signal; and
means for generating the gamma correction table of the blue digital signal.

12. The image scanning device according to claim 7, further comprising means for determining whether the test chart has been set at an auto document feeder or on a flat bed scanner.

13. The image scanning device according to claim 12, further comprising:
means for detecting that the test chart has been set at the auto document feeder; and
means for detecting that the test chart has been set on the flat bed scanner.

14. A calibration method of an image scanning device comprising the steps of:
determining a size of a test chart placed on a scanner unit;
selecting a storage unit storing target brightness of a plurality of patches of a test chart of the determined size and corresponding position information;
scanning the test chart by a photoelectric conversion element; and
calibrating a correction circuit by comparing brightness at a prescribed position on the test chart with target brightness corresponding to the prescribed position retrieved from the storage unit.

15. The calibration method of the image scanning device according to claim 14, further comprising the step of determining whether the test chart has been set on an auto document feeder or a flat bed scanner.

16. The calibration method of the image scanning device according to claim 15, further comprising the step of selecting one of a storage unit for the auto document feeder and a storage unit for the flat bed scanner according to whether the test chart is set on the auto document feeder or the flat bed scanner.

17. The calibration method of the image scanning device according to claim 14, further comprising the step of averaging brightness in one scanned patch.

18. The calibration method of the image scanning device according to claim 14, further comprising the step of rewriting a gamma correction table in the correction circuit to a calibrated value.

19. The calibration method of the image scanning device according to claim 18, further comprising the step of creating the calibrated value of the gamma correction table by an interleave calculation.
